(19) United States
(12) Patent Application Publication
(10) Pub. No.: US 2017/0161079 A1
(43) Pub. Date: Jun. 8, 2017

(54) METHOD, MOBILE TERMINAL AND TERMINAL FOR IMPLEMENTING WIRELESS CHARGING

(71) Applicants: LE HOLDINGS (BEIJING) CO., LTD., Beijing (CN); LEMOBILE INFORMATION TECHNOLOGY (BEIJING) CO., LTD, Beijing (CN)

(72) Inventor: Xufeng AN, Beijing (CN)

(21) Appl. No.: 15/242,071

(22) Filed: Aug. 19, 2016

Related U.S. Application Data
(63) Continuation of application No. PCT/CN2016/088850, filed on Jul. 6, 2016.

(30) Foreign Application Priority Data
Dec. 8, 2015 (CN) 201510897341.8

(51) Int. Cl. G06F 9/44

(52) U.S. Cl. CPC G06F 9/4403

(57) ABSTRACT

The present disclosure provides a method and a mobile terminal for implementing wireless charging. The method includes: in response to a first startup thread being triggered, starting and initializing boot; and, if it is determined that the first startup thread is triggered by a wireless charging event during the initialization phase of the boot, executing a wireless charging process logic after the initialization phase of the boot is completed and before the core is started. The method and the mobile terminal for implementing wireless charging may shorten the time taken for starting the wireless charging, and save electric power with no need of starting the core and application service in the upper layer.

### CROSS REFERENCE TO RELATED APPLICATION

This application is a continuation of International PCT Patent Application No. PCT/CN2016/088850, filed Jul. 6, 2016 (attached hereto as an Appendix), and claims benefit/priority of Chinese patent application No. 201510897341.8, filed with the State Intellectual Property Office of China on Dec. 8, 2015, which are all incorporated herein by reference in entirety.

### TECHNICAL FIELD

The present disclosure relates to the technical field of mobile terminal, and in particular, to a method, a mobile terminal and a terminal for implementing wireless charging.

### BACKGROUND

At present, wireless charging technology has been applied to mobile terminal such as mobile phone. By way of wireless charging technology, users may get rid of charging cable by which mobile phone is chained for a long time, thereby being facilitated in certain applications and security. The modes of wireless charging may be classified into two types: one is wireless charging in an on state (started), the other is wireless charging in an off state (shutdown).

In prior art, taking wireless charging of mobile phone in the off state as an example, a user may put a mobile phone in the off state on a wireless charger, and the mobile phone may trigger a startup process by the interruption of electromagnetic induction when detecting a charging network. Wherein, a boot is started and initialized, during initialization phase of the boot which whether the startup process is caused by triggering wireless charging is determined. If it is determined that the startup process is caused by triggering wireless charging, the mode of startup is set as wireless charging mode. Then the core is started normally, and finally, the application service in the upper layer is started and initialized. During the initialization phase of the application service, the mode of startup is detected firstly, and when that the mode of startup is a wireless charging mode is detected, a charging application which completes a task of charging function is started. Furthermore, the charging application may further perform the tasks such as shutdown alarm clock response function and keypress response function and so on.

However, during the process of implementing the present disclosure, inventors of the present disclosure find in the study that, in prior art, the boot, the core, the application service in the upper layer and the charging application in the upper layer have to be sequentially started for wireless charging in the off state, thus relatively large number of processes need to be started. As a result, on the one hand, starting wireless charging takes relatively long time, and on the other hand, the starting process itself may also cause power consumption of mobile phone. Therefore it leads to a problem that the power conversion efficiency is reduced during wireless charging, and it causes a waste of power.

### SUMMARY

The present disclosure is provided to solve the above described problems. One purpose of the present disclosure is to provide a method and a mobile terminal for implementing wireless charging so as to shorten the time taken for starting wireless charging and improve the power conversion efficiency in wireless charging.

According to the first aspect of the embodiments of the present disclosure, a method for implementing wireless charging may be provided, including: starting and initializing boot in response to a first startup thread being triggered; and if it is determined that the first startup thread is triggered by a wireless charging event during an initialization phase of the boot, executing a wireless charging process logic after the initialization phase of the boot is completed and before a core is started.

According to the second aspect, a non-volatile computer storage medium stores one or more modules. The one or more modules when performed by the a device make the device perform the following operation:

starting and initializing boot in response to a first startup thread being triggered;

and if it is determined that the first startup thread is triggered by a wireless charging event during an initialization phase of the boot, executing a wireless charging process logic after the initialization phase of the boot is completed and before a core is started.

According to the third aspect, an embodiments of the present disclosure further provide a mobile terminal, including:

one or more processors;

a memory;

wherein, the one or more processors are configured for:

starting and initializing boot in response to a first startup thread being triggered;

and if it is determined that the first startup thread is triggered by a wireless charging event during an initialization phase of the boot, executing a wireless charging process logic after the initialization phase of the boot is completed and before a core is started.

The method and the mobile terminal for implementing wireless charging according to the present disclosure can start to execute the wireless charging process logic after the initialization phase of the boot is completed and before the core is started, without firstly starting the core and the application service in the upper layer and then entering charging mode after the initialization phase of the boot is completed. In this way, the method for implementing wireless charging may shorten the starting time for wireless charging and save electric power with no need of starting the core and the application service in the upper layer.

### BRIEF DESCRIPTION OF THE DRAWINGS

The following description of the exemplary embodiments will be read with reference to the drawings, and other characteristics, features and advantages of the present disclosure would be apparent.

The drawings, which are incorporated into and form a part of the specification, illustrate some embodiments of the present disclosure, and explain the principle of the present disclosure together with the following descriptions. Throughout the drawings, similar reference numerals refer to similar elements. Note that, the drawings here referred to in the following description only illustrate some, not all, embodiments of the present disclosure. Other drawings may be gotten from these drawings by those skilled in the art without any inventive effort.

FIG. 1 is a flowchart illustrating a method for implementing wireless charging according to the present disclosure;

FIG. 2 is a flowchart illustrating the method for implementing wireless charging according to an particular embodiment of the present disclosure;

FIG. 3 is a flowchart illustrating a first startup thread according to the present disclosure;

FIG. 4 is a structural schematic view illustrating a mobile terminal for implementing wireless charging according to the present disclosure;

FIG. 5 is a structural schematic view illustrating a mobile terminal for implementing wireless charging according to an embodiment of the present disclosure; and

FIG. 6 is a structural schematic view illustrating a computer program of a mobile terminal for implementing wireless charging according to an embodiment of the present disclosure.

### DETAILED DESCRIPTION

In order to make the purposes, technical solutions and advantages more clear, technical solutions of the embodiments of the present disclosure will be described clearly and completely below with reference to the drawings of the embodiments of the present disclosure. Apparently, the embodiments to be described only illustrate some, not all of the embodiments of the present disclosure. Based on the embodiments of the present disclosure, all other embodiments gotten by those skilled in the art without any inventive effort fall into the scope of the present disclosure. It should be noted that, in the case of without conflict, the embodiments or the features in the embodiments in the present disclosure may be combined with each other freely without limitation.

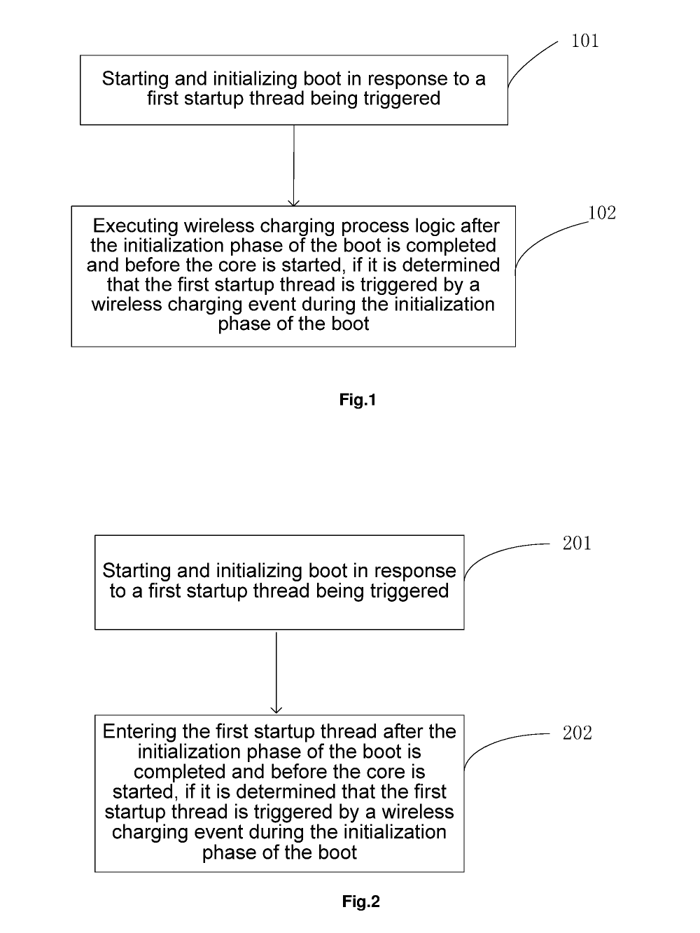

FIG. 1 is a flowchart illustrating a method for implementing wireless charging according to the present disclosure. The method for implementing wireless charging may include:

In Step 101, in response to a first startup thread being triggered, boot may be started and initialized.

In this step, the first startup thread of the mobile phone may be triggered by the interruption of electromagnetic induction. Particularly, whether the interruption of electromagnetic induction may be generated is detected, and if the interruption of electromagnetic induction is detected, then whether a wireless charging network exists may be detected. If the wireless charging network is detected, the first startup thread may be triggered.

In Step 102, if it is determined that the first startup thread is triggered by a wireless charging event during an initialization phase of the boot, the wireless charging process logic may be executed after the initialization phase of the boot is completed and before a core is started.

Wherein, if it is determined that the first startup thread is triggered by a wireless charging event during the initialization phase of the boot, the mode of startup may be set as wireless charging mode. In this way, after being started, the mobile phone may directly enter wireless charging mode. In practice, mobile phone may enter various modes after being started, such as reboot mode, factory default mode, charging mode (including wired charging mode or wireless charging mode). Different modes of startup may be set for the mobile phone due to different purposes of mobile phone startup, thus the mobile phone may, after startup, directly enter different modes of startup and execute its corresponding operation, thereby improving the operational efficiency.

Additionally, if it is determined that the first startup thread is not triggered by a wireless charging event, for example triggered by a long keypress, the mode of startup may be set as reboot mode.

Particularly, after the initialization phase of the boot is completed and before the core is started, a keypress process logic and/or shutdown alarm clock process logic may further be executed, which may be described in detail in the following embodiments.

FIG. 2 is a flowchart illustrating the method for implementing wireless charging according to a particular embodiment of the present disclosure. The embodiment of the method for implementing wireless charging includes:

In Step 201, in response to a first startup thread being triggered, boot may be started and initialized.

In Step 202, if it is determined that the first startup thread is triggered by a wireless charging event during an initialization phase of the boot, the first startup thread may be entered after the initialization phase of the boot is completed and before a core is started.

In the first startup thread, the following logic may be executed in the form of a single thread: wireless charging process logic, keypress process logic and shutdown alarm clock process logic; or wireless charging process logic and keypress process logic; or wireless charging process logic and shutdown alarm clock process logic.

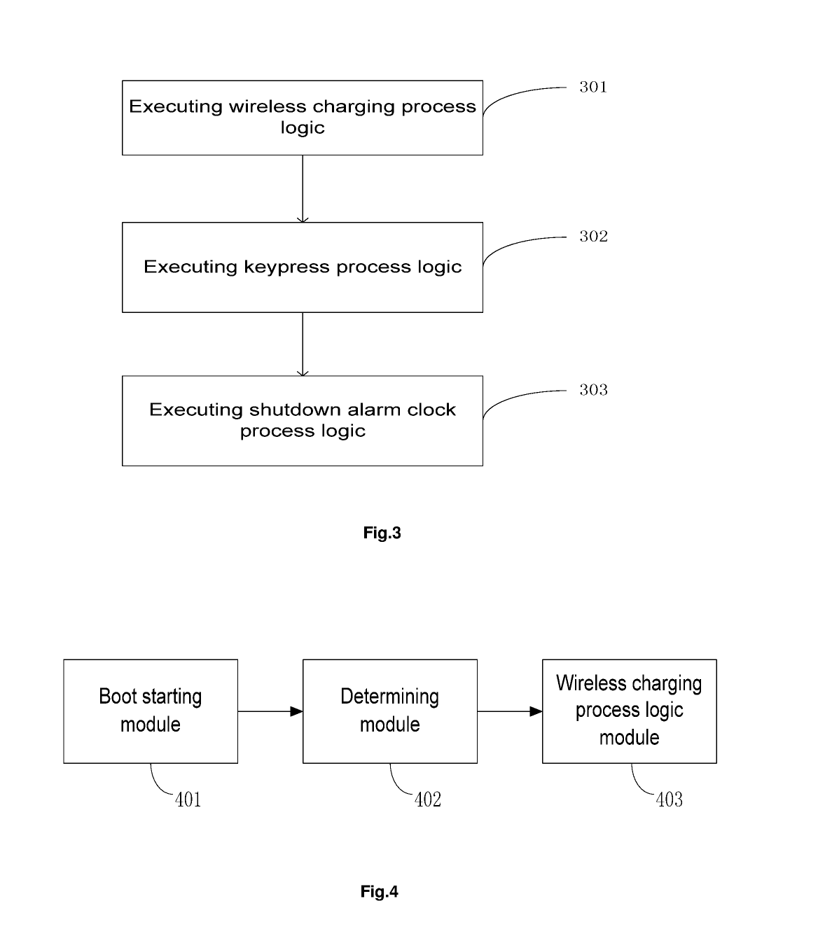

In the following, a sequence in which wireless charging process logic, keypress process logic and shutdown alarm clock process logic may be executed in a single thread will be exemplarily illustrated in FIG. 3. However, in practical operation, it is not limited to the sequence of executing the above process logics.

The operations of entering the first startup thread in Step 202 may include the process illustrated in FIG. 3. The process illustrated in FIG. 3 may be implemented in the form of single thread cycle. FIG. 3 only illustrates a single execution.

In Step 301, the wireless charging process logic may be executed to perform the operation of wireless charging.

In this step, the type of the wireless charger may be judged according to the information received from the wireless charger, and corresponding charging current may be set. In general, it may be set as 2A, 1.5A or other current values. When it is charged, a first threshold may be set, such as 90% of full capacity of the mobile phone. If the current capacity reaches the first threshold, the charging current may be reduced until the mobile phone is fully charged, and then the charging may be stopped. Furthermore, a second threshold may be set, such as 95% of the full capacity of the mobile phone, and after it is fully charged, if the capacity of the mobile phone is decreased to the second threshold due to the user's use, the charging may start again.

In Step 302: the keypress process logic may be executed.

In this step, it may be detected whether a short keypress operation exists, if yes, in response to the short keypress operation, the display screen of the mobile terminal may be lighted, and a charging chart may be drawn on the display screen for showing progress of charging; and if no, while loop may continue to be executed. It may be detected Whether a long keypress operation exist, if yes, a second startup thread may be triggered in response to a long keypress operation so as to restart the mobile terminal in the second startup thread; and if no, while loop may continue to be executed.

In Step 303: the shutdown alarm clock process logic may be executed.

In this step, it may be detected whether the alarming clock arrives at preset time, and if yes, a third startup thread may be triggered so as to restart the mobile terminal in the third startup thread. Particularly, during each of the cycles in the while loop, the information about the hardware register configured by the shutdown alarm clock may be read, and if the information about the shutdown alarm clock arriving at its preset time is detected, a third startup thread may be triggered.

Note that, the first startup thread illustrated in FIG. 3 may include wireless charging process logic, keypress process logic, and shutdown alarm clock process logic, however, according to the needs in practice, may include only wireless charging process logic and keypress process logic, or may include only wireless charging process logic and shutdown alarm clock process logic.

FIG. 4 illustrates a mobile terminal for implementing wireless charging according to the present disclosure, including:

a boot starting module 401, configured to start and initialize boot in response to a first startup thread being triggered;

a determining module 402, configured to determine whether the first startup thread is triggered by a wireless charging event during an initialization phase of the boot; and

a wireless charging process logic module 403, configured to execute wireless charging process logic after the initialization phase of the boot is completed and before a core is started.

The mobile terminal for implementing wireless charging may further include:

a startup mode setting module, configured to set the mode of startup as the wireless charging mode if it is determined that the first startup thread is triggered by a wireless charging event during the initialization phase of the boot.

Furthermore, the mobile terminal for implementing wireless charging may further include:

a keypress process logic module, configured to execute keypress process logic after the initialization phase of the boot is completed and before the core is started; and

a shutdown alarm clock process logic module, configured to execute shutdown alarm clock process logic after the initialization phase of the boot is completed and before the core is started.

Wherein, the keypress process logic module may be further configured to: detect whether a short keypress operation exists, and if yes, in response to the short keypress operation, the display screen of the mobile terminal may be lighted, and a charging chart may be drawn on the display screen for showing progress of charging; and detect whether a long keypress operation exists, and if yes, in response to a long keypress operation, the second startup thread may be triggered so as to restart the mobile terminal in the second startup thread.

The shutdown alarm clock process logic module may be further configured to detect whether the shutdown alarm clock arrives at the preset time, and if yes, the third startup thread may be triggered so as to restart the mobile terminal in the third startup thread.

The function of each of the modules in the mobile terminal for implementing wireless charging may be the same with the specific implementation modes in the method for implementing wireless charging, thus the detailed description is omitted for avoidance of redundancy.

The method and the mobile terminal for implementing wireless charging according to the present disclosure can start to execute wireless charging process logic after the initialization phase of the boot is completed and before the core is started, without firstly starting the core and the application service in the upper layer and then entering the charging mode after the initialization phase of the boot is completed . In this way, the method for implementing wireless charging according to the present disclosure may shorten the time taken for starting the wireless charging and save electric power with no need of starting the core and the application service in the upper layer.

According to the embodiments of the present disclosure, a terminal may be further provided, which includes the mobile terminal for implementing wireless charging according to any of the above device embodiments.

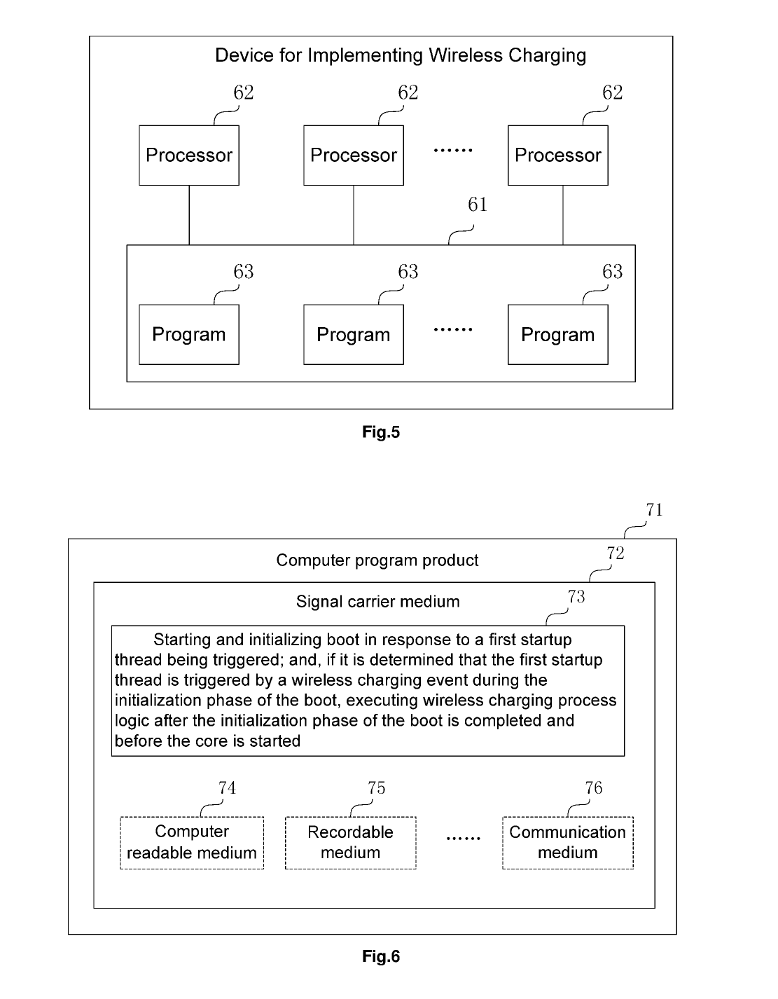

FIG. 5 is a structural schematic view illustrating the mobile terminal for implementing wireless charging according to an embodiment of the present disclosure. As illustrated in FIG. 5, the mobile terminal for implementing wireless charging according to an embodiment of the present disclosure includes a memory 61, one or more processors 62 and one or more programs 63.

Wherein, the one or more programs 63 may be configured to, when executed by one or more processors 62, execute any one of the methods in the above embodiments.

The mobile terminal for implementing wireless charging according to an embodiment of the present disclosure may be configured to, in response to a first startup thread being triggered, start and initialize boot, and, if it is determined that the first startup thread is triggered by a wireless charging event during an initialization phase of the boot, execute wireless charging process logic after the initialization phase of the boot is completed and before a core is started. The wireless charging process logic may be started to be executed after the initialization phase of the boot is completed and before the core is started, without firstly starting the core and the application service in the upper layer and then entering charging mode after the initialization phase of the boot is completed. In this way, the mobile terminal for implementing wireless charging may shorten the time taken for starting the wireless charging and save electric power with no need of starting the core and the application service in the upper layer.

FIG. 6 is a structural schematic view illustrating computer program of the mobile terminal for implementing wireless charging according to an embodiment of the present disclosure. As illustrated in FIG. 6, computer program product 71 of the mobile terminal for implementing wireless charging according to the embodiments of the present disclosure may include signal carrier medium 72. The signal carrier medium 72 may include one or more instructions 73, when the instructions 73 are executed by e.g. the processor, the processor may provide the above functions which are described with reference to FIG. 1 FIG. 3. For example, the instructions 73 may include: starting and initializing boot in response to a first startup thread being triggered, and, if it is determined that the first startup thread is triggered by a wireless charging event during an initialization phase of the boot, executing wireless charging process logic after the initialization phase of the boot is completed and before a core is completed. Thus, for example, referring to FIG. 1, the mobile terminal for implementing wireless charging may perform one or more of the steps illustrated in FIG. 1 in response to the instructions 73.

In some embodiments, the signal carrier medium 72 may include computer readable medium 74, such as but not limited to hard disk drive, compact disc (CD), digital versatile disk (DVD), digital tape and storage devices and so on. In some embodiments, the signal carrier medium 72 may include recordable medium 75, such as but not limited to memory, read/write (R/W) CD , R/W DVD and so on. In some embodiments, the signal carrier medium 72 may include communication medium 76, such as but not limited to digital and/or analogue communication medium (for example, optical fiber cable, waveguide, wired communication link and wireless communication link and so on). Thus, for example, the computer program product 71 may be transmitted to one or more modules of the mobile terminal for implementing wireless charging through RF signal carrier medium 72, wherein, the signal carrier medium 72 may be transmitted through wireless communication medium (for example, wireless communication medium in accordance with IEEE 802.11 standard).

The computer program product according to an embodiment of the present disclosure may be configured to, in response to a first startup thread being triggered, start and initialize boot, and, if it is determined that the first startup thread is triggered by a wireless charging event during the initialization phase of the boot, execute wireless charging process logic after the initialization phase of the boot is completed and before the core is started. The wireless charging process logic may be started to be executed after the initialization phase of the boot is completed and before the core is started, without firstly starting the core and the application service in the upper layer and then entering charging mode after the initialization phase of the boot is completed. In this way, the mobile terminal for implementing wireless charging may shorten the time taken for starting the wireless charging and save electric power with no need of starting the core and the application service in the upper layer.

By the description of the above embodiments, one skilled in the art may know clearly that the present embodiments may be achieved by virtue of software plus necessary general hardware platforms, of course, it may also be achieved by hardware. Based on such understanding, the technical solutions described above in essence or the part contributing to the prior art may be present in the form of a software product. The computer software product may be stored in a computer readable storage medium, such as read-only memory (ROM), random access memory (RAM), magnetic disk and CD, etc., containing some instructions to direct a computer equipment (may be a personal computer, a server, or network equipment and so on) to perform the method mentioned in various embodiments or certain parts of each embodiment of the present disclosure.

An embodiment of the present disclosure further provides a non-volatile computer storage medium storing one or more modules. The one or more modules when performed by the a device make the device perform the following operation:

starting and initializing boot in response to a first startup thread being triggered;

and if it is determined that the first startup thread is triggered by a wireless charging event during an initialization phase of the boot, executing a wireless charging process logic after the initialization phase of the boot is completed and before a core is started.

An embodiment of the present disclosure further provides a mobile terminal, including:

one or more processors;

a memory;

wherein, the one or more processors are configured for:

starting and initializing boot in response to a first startup thread being triggered;

and if it is determined that the first startup thread is triggered by a wireless charging event during an initialization phase of the boot, executing a wireless charging process logic after the initialization phase of the boot is completed and before a core is started.

The aforementioned description may be implemented individually or combined in various ways. These variant ways fall into the protection scope of the present disclosure.

Finally, it is noted that, the above embodiments are only provided to illustrate the technical solutions of the present disclosure, rather than limit the scope of the present disclosure. Although the present disclosure has been described in detail with reference to the above embodiments, those skilled in the art shall understand that, the technical solutions recorded in the above embodiments may be amended, or part of technical characters may be replaced or substituted with equivalent, without departing from the spirit and scope of the embodiments of the present disclosure.

1. A method for implementing wireless charging, comprising:
starting and initializing boot in response to a first startup thread being triggered; and
executing a wireless charging process logic after an initialization phase of the boot is completed and before a core is started, if it is determined that the first startup thread is triggered by a wireless charging event during the initialization phase of the boot.

2. The method for implementing wireless charging according to claim 1, wherein, the method further comprises:
setting mode of startup as wireless charging mode if it is determined that the first startup thread is triggered by the wireless charging event during the initialization phase of the boot.

3. The method for implementing wireless charging according to claim 2, wherein, the method further comprises:
executing a keypress process logic and/or a shutdown alarm clock process logic after the initialization phase of the boot is completed and before the core is started.

4. The method for implementing wireless charging according to claim 3, wherein, the step of executing a keypress process logic comprises:
detecting whether a short keypress operation exists, and if yes, in response to the short keypress operation, lighting a display screen of a mobile terminal and drawing a charging chart for showing progress of charging on the display screen; and
detecting whether a long keypress operation exists, and if yes, in response to the long keypress operation, triggering a second startup thread so as to restart the mobile terminal in the second startup thread.

5. The method for implementing wireless charging according to claim 3, wherein, the step of executing shutdown alarm clock process logic comprises:
detecting whether shutdown alarm clock arrives at preset time; and
triggering, if the shutdown alarm clock arrives at the preset time, a third startup thread, so as to restart the mobile terminal in the third startup thread.

6. The method for implementing wireless charging according to claim 3, wherein, after the initialization phase of the boot is completed and before the core is started, the following are executed cyclically in a single thread:
the wireless charging process logic, the keypress process logic and the shutdown alarm clock process logic; or
the wireless charging process logic and the keypress process logic; or
the wireless charging process logic and the shutdown alarm clock process logic.

7. A mobile terminal for implementing wireless charging, comprising:
one or more processors;
a memory;
wherein, the one or more processors are configured for:
starting and initializing boot in response to a first startup thread being triggered;
and if it is determined that the first startup thread is triggered by a wireless charging event during an initialization phase of the boot, executing a wireless charging process logic after the initialization phase of the boot is completed and before a core is started.

8. The mobile terminal for implementing wireless charging according to claim 7, wherein, the mobile terminal further comprises:
a startup mode setting module, configured to set mode of startup as wireless charging mode if it is determined that the first startup thread is triggered by the wireless charging event during the initialization phase of the boot.

9. The mobile terminal for implementing wireless charging according to claim 7 or 8, wherein, the mobile terminal further comprises:
a keypress process logic module, configured to execute keypress process logic after the initialization phase of the boot is completed and before the core is started; and
a shutdown alarm clock process logic module, configured to execute shutdown alarm clock process logic after the initialization phase of the boot is completed and before the core is started.

10. The mobile terminal for implementing wireless charging according to claim 9, wherein, the keypress process logic module is further configured for:
detecting whether a short keypress operation exists, and if yes, in response to the short keypress operation, lighting a display screen of mobile terminal and drawing a charging chart for showing progress of charging on the display screen; and
detecting whether a long keypress operation exists, and if yes, in response to the long keypress operation, triggering a second startup thread so as to restart the mobile terminal in the second startup thread.

11. The mobile terminal for implementing wireless charging according to claim 9, wherein, the shutdown alarm clock process logic module is further configured for:
detecting whether shutdown alarm clock arrives at preset time; and
triggering, if the shutdown alarm clock arrives at the preset time, a third startup thread so as to restart the mobile terminal in the third startup thread.

12. A non-volatile computer storage medium, comprising: the computer storage medium stores one or more modules. The one or more modules when performed by the a device make the device perform the following operation:
starting and initializing boot in response to a first startup thread being triggered;
and if it is determined that the first startup thread is triggered by a wireless charging event during an initialization phase of the boot, executing a wireless charging process logic after the initialization phase of the boot is completed and before a core is started.

13. The non-volatile computer storage medium according to claim 12, wherein, the mobile terminal further comprises:
a startup mode setting module, configured to set mode of startup as wireless charging mode if it is determined that the first startup thread is triggered by the wireless charging event during the initialization phase of the boot.

14. The non-volatile computer storage medium according to claim 13, wherein, the mobile terminal further comprises:
a keypress process logic module, configured to execute keypress process logic after the initialization phase of the boot is completed and before the core is started; and
a shutdown alarm clock process logic module, configured to execute shutdown alarm clock process logic after the initialization phase of the boot is completed and before the core is started.

15. The non-volatile computer storage medium according to claim 14, wherein, the keypress process logic module is further configured for:
detecting whether a short keypress operation exists, and if yes, in response to the short keypress operation, lighting a display screen of mobile terminal and drawing a charging chart for showing progress of charging on the display screen; and
detecting whether a long keypress operation exists, and if yes, in response to the long keypress operation, triggering a second startup thread so as to restart the mobile terminal in the second startup thread.

16. The non-volatile computer storage medium according to claim 14, wherein, the shutdown alarm clock process logic module is further configured for:
detecting whether shutdown alarm clock arrives at preset time; and
triggering, if the shutdown alarm clock arrives at the preset time, a third startup thread so as to restart the mobile terminal in the third startup thread.

17. The method for implementing wireless charging according to claim 4, wherein, the step of executing shutdown alarm clock process logic comprises:
detecting whether shutdown alarm clock arrives at preset time; and
triggering, if the shutdown alarm clock arrives at the preset time, a third startup thread, so as to restart the mobile terminal in the third startup thread.

18. The method for implementing wireless charging according to claim 17, wherein, after the initialization phase of the boot is completed and before the core is started, the following are executed cyclically in a single thread:
the wireless charging process logic, the keypress process logic and the shutdown alarm clock process logic; or
the wireless charging process logic and the keypress process logic; or
the wireless charging process logic and the shutdown alarm clock process logic.

19. The mobile terminal for implementing wireless charging according to claim 10, wherein, the shutdown alarm clock process logic module is further configured for:
detecting whether shutdown alarm clock arrives at preset time; and
triggering, if the shutdown alarm clock arrives at the preset time, a third startup thread so as to restart the mobile terminal in the third startup thread.

20. The non-volatile computer storage medium according to claim 15, wherein, the shutdown alarm clock process logic module is further configured for:
detecting whether shutdown alarm clock arrives at preset time; and
triggering, if the shutdown alarm clock arrives at the preset time, a third startup thread so as to restart the mobile terminal in the third startup thread.
